(19) United States
(12) Patent Application Publication
(10) Pub. No.: US 2016/0257615 A1
(43) Pub. Date: Sep. 8, 2016

(54) Process and method of creating "REPO-ROCK" which is formulated from the repossession of recylec materials

(71) Applicants: Evelyn White, Fredericksburg, VA (US); Michael Crute, Spotsylvania, VA (US)

(72) Inventors: Evelyn White, Fredericksburg, VA (US); Michael Crute, Spotsylvania, VA (US)

(21) Appl. No.: 14/544,877

(22) Filed: Mar. 2, 2015

(51) Int. Cl. C04B 26/02; B29B 17/00

(52) U.S. Cl. CPC C04B 26/02; B29B 17/0005

(57) ABSTRACT

An artificial decorative rock formed plastic recycled elements which include a body with an outer surface being constructed of layer of epoxy resin filled with hard sand-type particles or standard concrete. The outer surface of the artificial decorative rock having at one recess or protrusion. The recess at least lightens up the weight of the structure or the protrusion can be used to stabilize the rock if so desired. Furthermore the recess or protrusion can be manipulated to have a variety of functions.

### BRIEF SUMMARY

### Background of the Invention

Recycle does not appear to being fully utilized at present. Metal that is recycled is usually melted down and recast as something else. Glass is melted down and reused. Glass is even crushed up and used in asphalt as well. Plastic is reused in injection molding machines but it the plastic that can be melted down safely without release of toxins. The plastic is then melted and recast into a number of parts. This leaves a great deal of recycle which is not being utilized. These unused resources end up in landfills which defeats the purpose of recycling.

Now the present invention presents a solution to the current problem. A process in creating synthetic rocks will reuse otherwise unusable plastic products. Natural rocks are heavy and confined to look of the rock. Similarly artificial rocks made of concrete or plaster of Paris appear to be undesirably heavy as mentioned in U.S. Pat. No. 4,385,088. The process or method allows the rock being made out of any hardening surface such as concrete or plaster due to those methods of invention. The artificial rock can be light in weight and reasonably easily handled especially since these rocks will be made to order of almost any size which can be small hand held rock or structure which extend for many feet.

### SUMMARY OF THE INVENTION

The invention can be configured into practically any shape or size. The Purpose is create what is commonly being called Green Technology which is technology that help the environment in particular. It was a concept is for a product called REPO-ROCKS. There will also be a whole line of new products which are called REPO-MINIS being medallion or tile size, REPO-LAWN ORNAMENTS, REPO-PAVERS, and REPO-BOULDS which are custom size boulders for a natural look or any look desired for flowerbeds, pond setting or meditations gardens for example. The conception of the idea came from a desire to use reclaimed plastic recycle especially recycle that was unfit for the extrusion process or reproduction into plastic pellets.

No doubt, the removal of such recycle from our landfills and waters. Thereby making the environment safer for all, including wildlife, birds and water creature, who presently run the risk of dying from ingesting or being caught up in plastic debris found on land and water. REPO-rock weigh a fraction of the weight of natural rock saving you man-power and equipment cost. Custom colors can be used to make all kinds of shades and pattern. Each ROCK is unique because they are hand crafted however this does not preclude the use of industrialization which would create templates. The outer layer is formed of a plaster, stone, exterior which would of course make the rock lighter in weight as well as a recess in exterior. The protrusion would add stability to the structure. This is the REPO-ROCK PRODUCT-LINE. The specification refers to a recess however, it is clear that a hole, opening, aperture, or channel would be synonyms for recess. The term recess is used by would encompass these other synonmys.

According to the invention a method of making REPO-ROCK will yield a product which is an apparatus which will be set out. The method is set out below. The recycle is gathered up in a mesh material which can be selected from wire or plastic. Afterwards the shape is set to whatever preference desired. The plaster or concrete or liquid epoxy resin and a relatively hard sand grain sized particles. It is also known in the art to spray such outer surfaces as taught in U.S. Pat. No. 4,385,088 which is incorporated by reference. The surface is applied by hand, spray, or tools such as a trial leaving a recess or protrusion. This is the simplest form. However, the more complex forms incorporated sensor, lights, pumps, switches, waterfalls, storage compartments, water hoses, clocks, electrical sockets, phone jacks, power stations for phone, motion sensors, alarms, weather gages, microwave, stove, and anything that can run off of electric power.

The technology stems from the recess or protrusion because this space can be configure for a conduit system made pvc or tubing which can even be made from recycle if so desired. This conduit system can carry either water or electrical wires through the rock which is configured to have a pump, a socket or chord with a plug. Once you have either put conduit in for electrical and/or water. The aforementioned possibilities of electrical products can be installed or a water works system. One skilled in the art of electronic can easily wire the rock for power and now a plurality or recess and/or protrusions can be installed in the outer surface for all of the functions mentioned dealing with electric. One skilled in the art with water pumps and conduit can easily supply water to anywhere on the rock to either a protrusion or recess.

It is noted that the conduit can take any path chosen. The product line begins with a simple rock with a recess or protrusion and other various based on demand stem from the original design. Since size and shape will be dictated by demand and preference it clearly that these recesses and/or protrusions can be fitted different sized electrical elements, water works, storage compartments. The utility is unmistakably apparent. These can be simple stones or vast boulders which include a variety of options mentioned above. It would be nice to have a rock by the pool to keep valuables from getting wet or lost, key could be placed in to a key or combination storage compartment. Rocks can be configured to contain music equipment, tv's, lights for security or pleasure etc. The possibilities when mapped out are almost endless. The concept of construction has been laid out as well as the utility of the end result product. The strength of the rock is derived from the exterior surface which is formidable after fully curing.

It is also understood that the water elements being the water fall does not have to have a pump but merely needs a hose which can be connected to a water spigot just having water flow out of even a sprinkler. water nozzle, and a diffuser to create a shower. This would be done by having first and second recesses with a hose attached. A pump could be installed by electric would be necessary in such a configuration. The body has a plurality of conduits, more than two recess with different recesses being connected to electrical wire and said hose with a water pump being connected to said hose and a reservoir inside said interior core.

### DRAWING DESCRIPTION

### Drawing

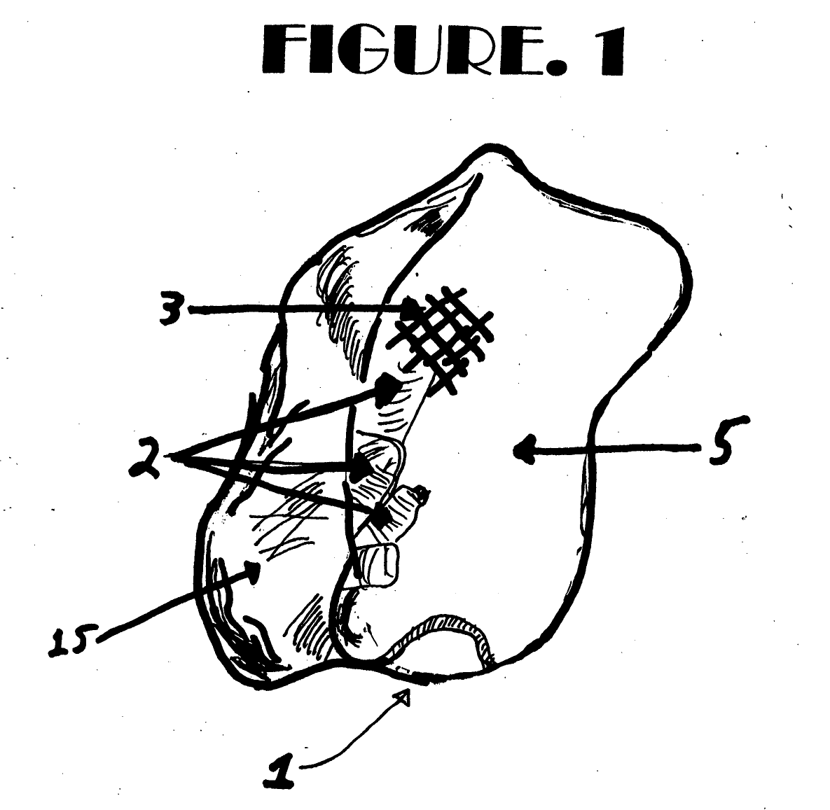

FIG. 1 is an exploited view of the apparatus showing simplest form with recess

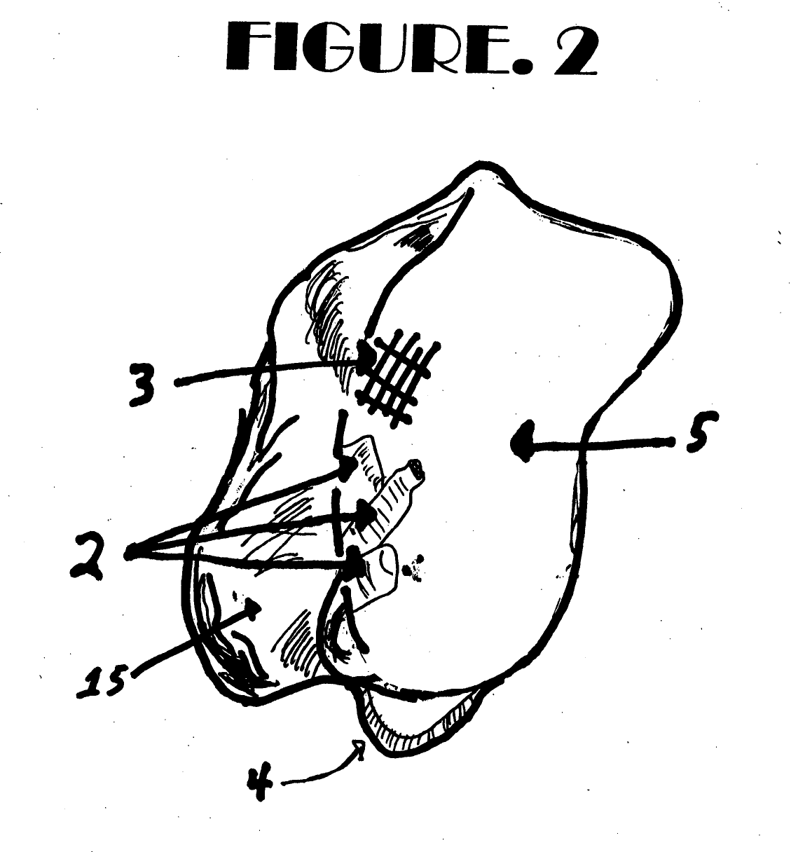

FIG. 2 shows the block of FIG. 1 sculptured to rock-like form;

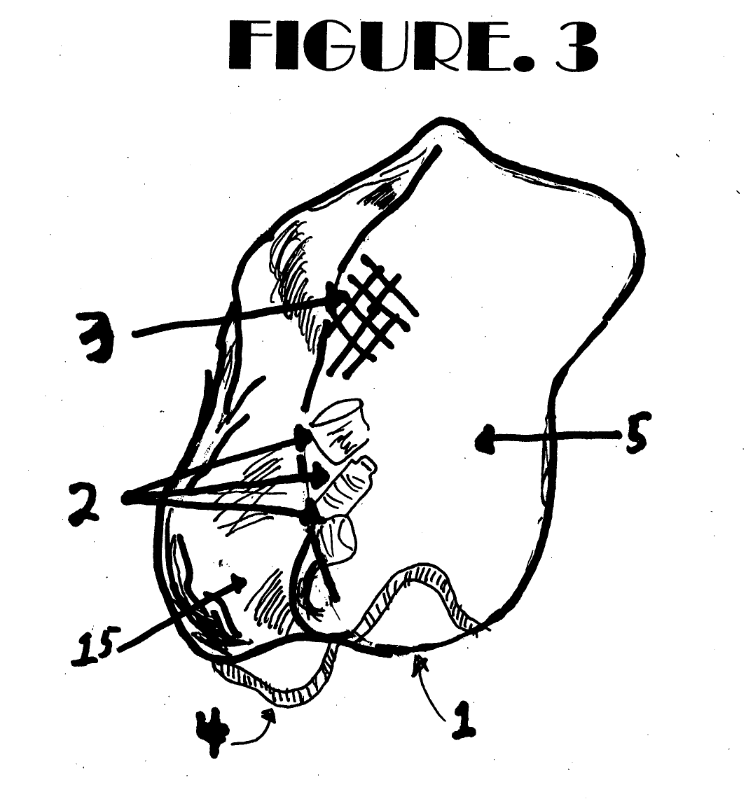

FIG. 3 shows the spraying of the sculptured form with a coating;

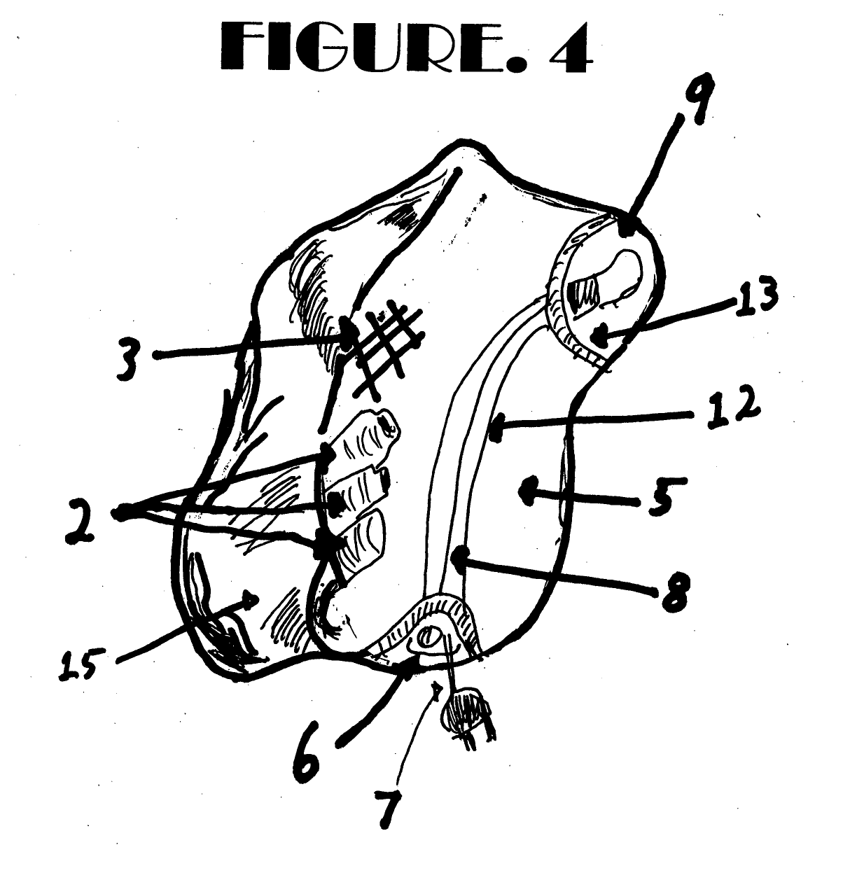

FIG. 4 is an enlarged section of FIG. 3 showing additional details;

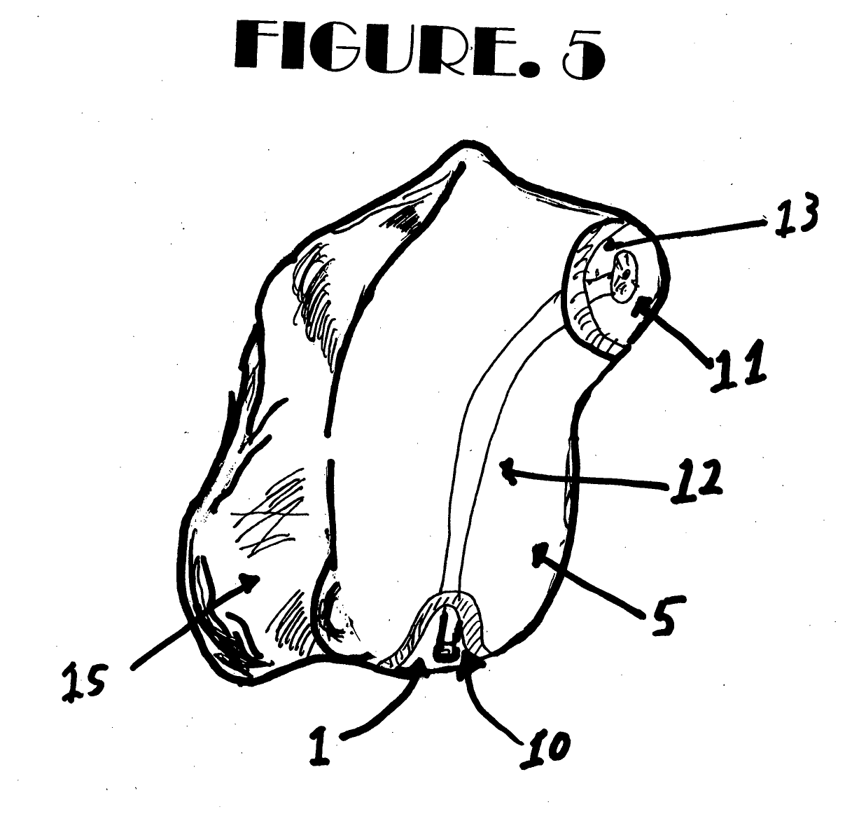

FIG. 5 is a further enlarged section of a modified rock-like form; and

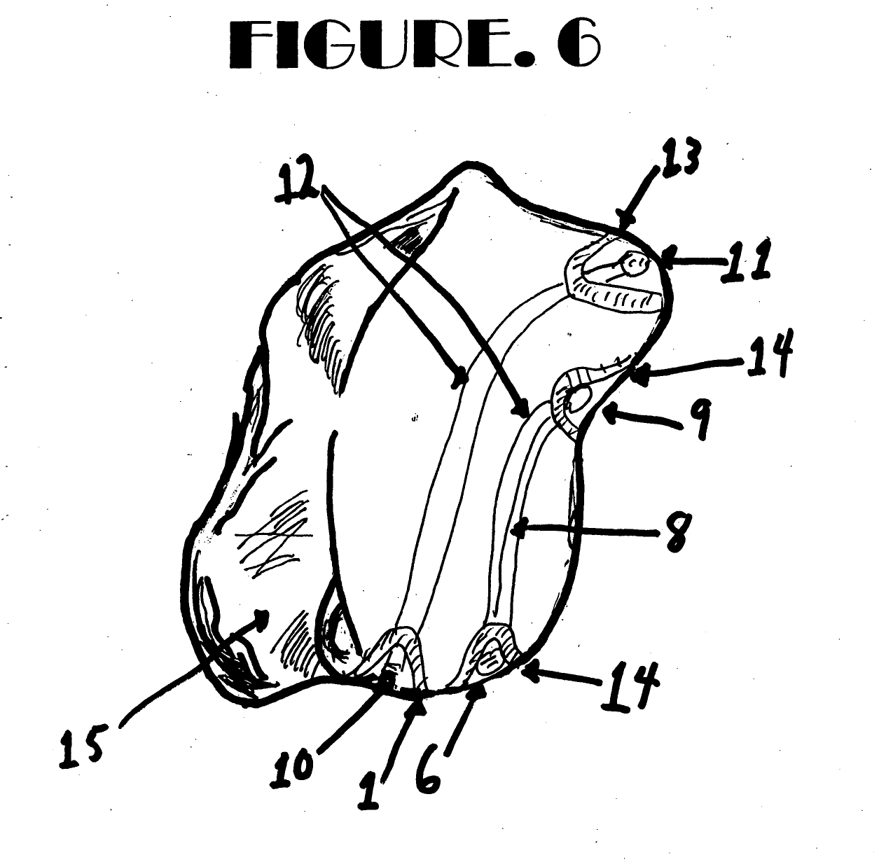

FIG. 6 is a vertical sectional view showing the molding of a rock-like container.

### DETAILED DESCRIPTION

### Description

Not all possibilities are illustrated however all disclosed and claimed combinations are clearly evident from the concepts and combinations taught above. Furthermore the placement of the elements in the drawings show how the configuration works because the position of element can be moved with respect to what is shown in the illustrated drawings.

FIG. 1 discloses the rock as made by the method disclosed above which shows the apparatus as a finished rock with the interior of the rock being shown. The outer surface is shown by element number 15. The exploited view as show what would be inside of the rock but cover by the outer surface. The rock has a recess 1, the hollow area showing what is inside of the rock 5, a mesh would could be made out of plastic or metal 3, and the recycle which is being used in the body of rock 2. This is the simplest form of the rock or apparatus.

FIG. 2 discloses the rock as made by the method disclosed above which shows the apparatus as a finished rock with the interior of the rock being shown. The outer surface is shown by element number 15. The exploited view as show what would be inside of the rock but cover by the outer surface. The rock has a protrusion 4, the hollow area showing what is inside of the rock 5, a mesh would could be made out of plastic or metal 3, and the recycle which is being used in the body of rock 2. This is the second simplest form of the rock or apparatus.

FIG. 3 discloses the rock as made by the method disclosed above which shows the apparatus as a finished rock with the interior of the rock being shown. The outer surface is shown by element number 15. The exploited view as show what would be inside of the rock but cover by the outer surface. The rock has a recess 1, a protrusion 4, the hollow area showing what is inside of the rock 5, a mesh would could be made out of plastic or metal 3, and the recycle which is being used in the body of rock 2. This is the third simplest form of the rock or apparatus.

FIG. 4 discloses the rock as made by the method disclosed above which shows the apparatus as a finished rock with the interior of the rock being shown. The outer surface is shown by element number 15. The exploited view as show what would be inside of the rock but cover by the outer surface. The rock has a recess which is not label in this figure, the hollow area showing what is inside of the rock 5, a mesh would could be made out of plastic or metal 3, a second recess 13, a light source 9, conduit which is used for either electrical or water 12, electrical wiring 8, an electric socket 6, an electrical plug 7, and the recycle which is being used in the body of rock 2.

FIG. 5 discloses the rock as made by the method disclosed above which shows the apparatus as a finished rock with the interior of the rock being shown. The outer surface is shown by element number 15. The exploited view as show what would be inside of the rock but cover by the outer surface. The rock has a recess 1, the hollow area showing what is inside of the rock 5, a second recess 13, a water spigot 11 or any such water element which is describe above could be placed in place of the spigot 11, conduit which is used for either electrical or water 12, a hose coupling 10, and the elements not shown but are part of the invention are the recycle which is being used in the body of rock 2, and mesh 3.

FIG. 6 discloses the rock as made by the method disclosed above which shows the apparatus as a finished rock with the interior of the rock being shown. The outer surface is shown by element number 15. The exploited view as show what would be inside of the rock but cover by the outer surface. The rock has a recess 1, a second recess 13, a hose coupling 10, a light source 9, a water spigot 11 or any such water element which is describe above could be placed in place of the spigot 11, conduit which is used for either electrical or water 12, electrical wiring 8, an electric socket 6, a plurality of recess beyond two 14, and the elements of the apparatus not shown which are part of the invention are recycle which is being used in the body of rock 2, and mesh 2.

Although not all of the combinations are not shown, all of the combinations recited above in the summary of the invention could have been illustrated and were clearly conceived during the conception of the invention. Any random combinations could have been shown other than what FIGS. 1-6 display. It should be understood that the present disclosure is for the purpose of illustration only and that this invention includes all modifications and equivalents which fall within the scope of the appended claims.

1. An apparatus comprising:
a body with an outer surface a strengthening layer of epoxy resin filled with hard sand-grain-sized particles which is attached on a mesh being a layer:
at least one plastic recycled element which forms an interior core;
and at least a first recess which is recessed inside of said outer surface.

2. The apparatus according to claim 1 wherein
the body has a plurality of conduits connecting to said first recess and having a second recess with a plug and switch with electrical wiring connecting said first and second recesses with a socket in said first recess.

3. The apparatus according to claim 1 wherein the body has an electrical element placed in said first recess selected from the group consisting of: sensor, lights, pumps, switches, waterfalls, storage compartments, clocks, electrical sockets, phone jacks, power stations for phone, motion sensors,
alarms, weather gages, microwave, stove, music equipment, and televisions.

4. The apparatus according to claim 3 wherein
the body has which has a plurality of recess greater than two which contain a plurality of said electrical elements within said plurality of recesses.

5. The apparatus according to claim 1 wherein
the body has a conduit connecting to said recess and having a second recess having a first hose coupling with a second hose coupling in said first recess.

6. The apparatus according to claim 5 wherein said first recess having a second hose has an attachment selected from the group consisting of sprinkler, water nozzle, and a diffuser to create a shower.

7. The apparatus according to claim 6 wherein said body has a plurality of conduits, more than two recess with different recesses being connected to electrical wire and said hose with a water pump being connected to said hose and a reservoir inside said interior core.

8. An apparatus comprising:
a body with an outer surface a strengthening layer of epoxy
resin filled with hard sand-grain-sized particles which is attached on a mesh being a layer
at least one plastic recycled element which forms an interior core;
and at least one protrusion which is extending in a direction opposite said interior core above said outer surface.

9. The apparatus according to claim 8 wherein the body has a plurality of conduits connecting to said first protrusion and having a second recess with a plug and switch
with electrical wiring connecting said first and second recesses with a socket in said first recess.

10. Tire apparatus according to claim 8 wherein the body has an electrical element placed in said first recess
sockets, phone jacks, power stations for phone, motion sensors, alarms, weather gages, microwave, stove, music equipment, and televisions.

11. The apparatus according to claim 8 wherein the body has which has a plurality of protrusion.
which contain a plurality of said electrical elements within said plurality of protrusions.

12. The apparatus according to claim 8 wherein the body has a conduit connecting to said protrusion and having
a second protrusion having a first hose coupling with a second hose coupling in said first protrusion.

13. The apparatus according to claim 8 wherein said first protrusion having a second hose has an attachment selected from the group consisting of sprinkler, water nozzle, and a diffuser to create a shower.

14. The apparatus according to claim 9 wherein said body has a plurality of conduits, more that two protrusions with different protrusions being connected to electrical wire and said hose with a water pump being connected to said hose and a reservoir inside said interior core.

15. An method of manufacturing an apparatus comprising steps of:
a step of making a body with an outer surface a strengthening layer of epoxy resin filled with hard sand-grain sized particles:
a step of having at least one plastic recycled element which forms an interior core;
and at least a first recess which is recessed inside of said outer surface or said recessed inside of a protrusion from said outer surface.

16. (canceled)

17. (canceled)

18. The apparatus according to claim 1 wherein said mesh selected from the group consisting of paper, metal and plastic.
